(19) United States
(12) Patent Application Publication
(10) Pub. No.: US 2024/0129782 A1
(43) Pub. Date: Apr. 18, 2024

(54) TECHNIQUES FOR EXCLUDING SIGNAL MEASUREMENTS FROM A MEASUREMENT REPORT

(71) Applicant: QUALCOMM Incorporated, San Diego, CA (US)

(72) Inventors: Jianqiang ZHANG, Beijing (CN); Arvind Vardarajan SANTHANAM, San Diego, CA (US); Xianwei ZHU, Beijing (CN); Hewu GU, Shanghai (CN); Jie MAO, Beijing (CN); Xiaochen CHEN, Beijing (CN); Xuqiang ZHANG, Beijing (CN); Jun DENG, Shanghai (CN); Peng HU, Beijing (CN)

(21) Appl. No.: 18/547,766

(22) PCT Filed: May 5, 2021
(86) PCT No.: PCT/CN2021/091818

§ 371 Date: Aug. 24, 2023

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may receive a first signal associated with a first radio access technology (RAT) and a second signal associated with a second RAT. The UE may determine that first signal measurements associated with the first signal satisfy a first condition and second signal measurements associated with the second signal satisfy a second condition. The UE may transmit, to a first base station associated with the first RAT, a measurement report that excludes the first signal measurements and the second signal measurements based at least in part on the first condition and the second condition being satisfied. Numerous other aspects are described.

### FIELD OF THE DISCLOSURE

Aspects of the present disclosure generally relate to wireless communication and to techniques and apparatuses for excluding signal measurements from a measurement report.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a base station via the downlink and uplink. “Downlink” (or “forward link”) refers to the communication link from the base station to the UE, and the “uplink” (or “reverse link”) refers to the communication link from the UE to the base station. As will be described in more detail herein, a base station may be referred to as a Node B, a gNB, an access point (AP), a radio head, a transmit receive point (TRP), a New Radio (NR) base station, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a first signal associated with a first radio access technology (RAT) and a second signal associated with a second RAT; determining that first signal measurements associated with the first signal satisfy a first condition and second signal measurements associated with the second signal satisfy a second condition; and transmitting, to a first base station associated with the first RAT, a measurement report that excludes the first signal measurements and the second signal measurements based at least in part on the first condition and the second condition being satisfied.

In some aspects, the first RAT is associated with a Long Term Evolution (LTE) network and the second RAT is associated with a New Radio (NR) network, and wherein the first signal is associated with an LTE cell and the second signal is associated with an NR cell.

In some aspects, the first RAT is associated with a serving cell and the second RAT is associated with a neighbor cell.

In some aspects, the first condition is satisfied when a reference signal received power (RSRP) associated with the first RAT satisfies a first threshold value and when a signal-to-noise ratio (SNR) associated with the first RAT satisfies a second threshold value.

In some aspects, the second condition is satisfied when a reference signal received quality (RSRQ) associated with the second RAT does not satisfy a third threshold value and when a signal-to-interference plus noise-ratio (SINR) associated with the second RAT does not satisfy a fourth threshold value.

In some aspects, the method includes receiving, from the first base station, an event configuration associated with a first event and a second event, wherein the first event and the second event are satisfied based at least in part on the first signal and the second signal.

In some aspects, the UE is not handed over or redirected to a second base station associated with the second RAT based at least in part on the first signal measurements and the second signal measurements.

In some aspects, the method includes dropping the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

In some aspects, a UE for wireless communication includes a memory and one or more processors, coupled to the memory, configured to: receive a first signal associated with a first RAT and a second signal associated with a second RAT; determine that first signal measurements associated with the first signal satisfy a first condition and second signal measurements associated with the second signal satisfy a second condition; and transmit, to a first base station associated with the first RAT, a measurement report that excludes the first signal measurements and the second signal measurements based at least in part on the first condition and the second condition being satisfied.

In some aspects, the first RAT is associated with an LTE network and the second RAT is associated with an NR network, and wherein the first signal is associated with an LTE cell and the second signal is associated with an NR cell.

In some aspects, the first RAT is associated with a serving cell and the second RAT is associated with a neighbor cell.

In some aspects, the first condition is satisfied when an RSRP associated with the first RAT satisfies a first threshold value and when an SNR associated with the first RAT satisfies a second threshold value.

In some aspects, the second condition is satisfied when an RSRQ associated with the second RAT does not satisfy a third threshold value and when an SINR associated with the second RAT does not satisfy a fourth threshold value.

In some aspects, the one or more processors are further configured to: receive, from the first base station, an event configuration associated with a first event and a second event, wherein the first event and the second event are satisfied based at least in part on the first signal and the second signal.

In some aspects, the UE is not handed over or redirected to a second base station associated with the second RAT based at least in part on the first signal measurements and the second signal measurements.

In some aspects, the one or more processors are further configured to: drop the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

In some aspects, a non-transitory computer-readable medium storing a set of instructions for wireless communication includes one or more instructions that, when executed by one or more processors of a UE, cause the UE to: receive a first signal associated with a first RAT and a second signal associated with a second RAT; determine that first signal measurements associated with the first signal satisfy a first condition and second signal measurements associated with the second signal satisfy a second condition; and transmit, to a first base station associated with the first RAT, a measurement report that excludes the first signal measurements and the second signal measurements based at least in part on the first condition and the second condition being satisfied.

In some aspects, the first RAT is associated with an LTE network and the second RAT is associated with an NR network, and wherein the first signal is associated with an LTE cell and the second signal is associated with an NR cell.

In some aspects, the first RAT is associated with a serving cell and the second RAT is associated with a neighbor cell.

In some aspects, the first condition is satisfied when an RSRP associated with the first RAT satisfies a first threshold value and when an SNR associated with the first RAT satisfies a second threshold value.

In some aspects, the second condition is satisfied when an RSRQ associated with the second RAT does not satisfy a third threshold value and when an SINR associated with the second RAT does not satisfy a fourth threshold value.

In some aspects, the one or more instructions further cause the UE to: receive, from the first base station, an event configuration associated with a first event and a second event, wherein the first event and the second event are satisfied based at least in part on the first signal and the second signal.

In some aspects, the UE is not handed over or redirected to a second base station associated with the second RAT based at least in part on the first signal measurements and the second signal measurements.

In some aspects, an apparatus for wireless communication includes means for receiving a first signal associated with a first RAT and a second signal associated with a second RAT; means for determining that first signal measurements associated with the first signal satisfy a first condition and second signal measurements associated with the second signal satisfy a second condition; and means for transmitting, to a first base station associated with the first RAT, a measurement report that excludes the first signal measurements and the second signal measurements based at least in part on the first condition and the second condition being satisfied.

In some aspects, the first RAT is associated with an LTE network and the second RAT is associated with an NR network, and wherein the first signal is associated with an LTE cell and the second signal is associated with an NR cell.

In some aspects, the first RAT is associated with a serving cell and the second RAT is associated with a neighbor cell.

In some aspects, the first condition is satisfied when an RSRP associated with the first RAT satisfies a first threshold value and when an SNR associated with the first RAT satisfies a second threshold value.

In some aspects, the second condition is satisfied when an RSRQ associated with the second RAT does not satisfy a third threshold value and when an SINR associated with the second RAT does not satisfy a fourth threshold value.

In some aspects, the apparatus includes means for receiving, from the first base station, an event configuration associated with a first event and a second event, wherein the first event and the second event are satisfied based at least in part on the first signal and the second signal.

In some aspects, the apparatus is not handed over or redirected to a second base station associated with the second RAT based at least in part on the first signal measurements and the second signal measurements.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a handover based at least in part on signal measurements, in accordance with the present disclosure.

FIG. 4 is a diagram illustrating an example associated with excluding signal measurements from a measurement report, in accordance with the present disclosure.

FIG. 5 is a diagram illustrating an example process associated with excluding signal measurements from a measurement report, in accordance with the present disclosure.

FIG. 6 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

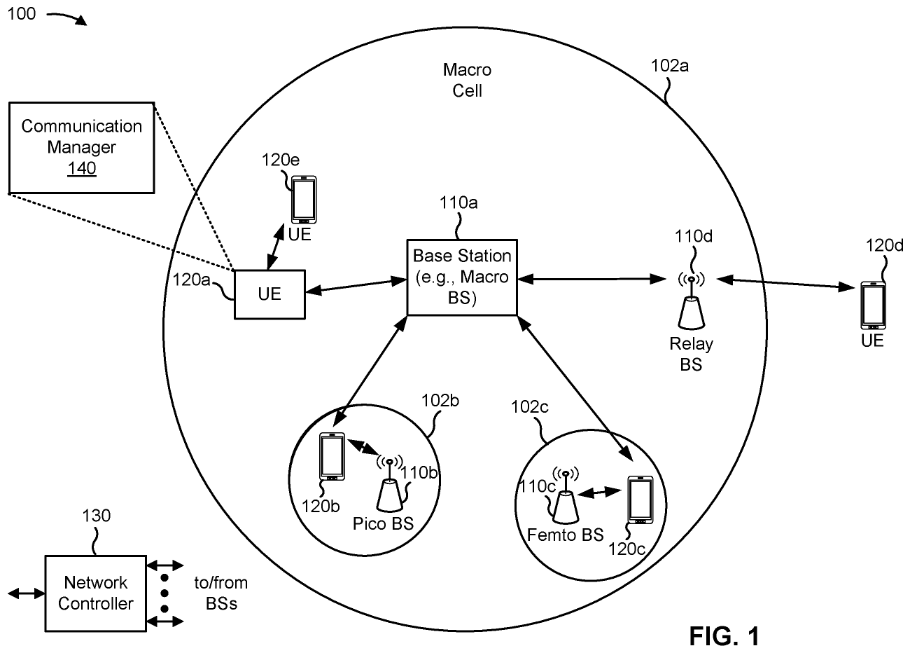

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR base station, a Node B, a gNB, a 5G node B (NB), an access point, a transmit receive point (TRP), or the like. Each base station may provide communication coverage for a particular geographic area. In 3GPP, the term “cell” can refer to a coverage area of a base station and/or a base station subsystem serving this coverage area, depending on the context in which the term is used.

A base station may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A base station for a macro cell may be referred to as a macro base station. A base station for a pico cell may be referred to as a pico base station. A base station for a femto cell may be referred to as a femto base station or a home base station. In the example shown in FIG. 1, a base station 110a may be a macro base station for a macro cell 102a, a base station 110b may be a pico base station for a pico cell 102b, and a base station 110c may be a femto base station for a femto cell 102c. A base station may support one or multiple (e.g., three) cells. The terms “eNB”, “base station”, “NR base station”, “gNB”, “TRP”, “AP”, “node B”, “5G NB”, and “cell” may be used interchangeably herein.

In some aspects, a cell may not necessarily be stationary, and the geographic area of the cell may move according to the location of a mobile base station. In some aspects, the base stations may be interconnected to one another and/or to one or more other base stations or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a base station or a UE) and send a transmission of the data to a downstream station (e.g., a UE or a base station). A relay station may also be a UE that can relay transmissions for other UEs. In the example shown in FIG. 1, a relay base station 110d may communicate with macro base station 110a and a UE 120d in order to facilitate communication between base station 110a and UE 120d. A relay base station may also be referred to as a relay station, a relay base station, a relay, or the like.

Wireless network 100 may be a heterogeneous network that includes base stations of different types, such as macro base stations, pico base stations, femto base stations, relay base stations, or the like. These different types of base stations may have different transmit power levels, different coverage areas, and different impacts on interference in wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to a set of base stations and may provide coordination and control for these base stations. Network controller 130 may communicate with the base stations via a backhaul. The base stations may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, a UE (e.g., UE 120) may include a communication manager 140. As described in more detail elsewhere herein, the communication manager 140 may receive a first signal associated with a first RAT and a second signal associated with a second RAT; determine that first signal measurements associated with the first signal satisfy a first condition and second signal measurements associated with the second signal satisfy a second condition; and transmit, to a first base station associated with the first RAT, a measurement report that excludes the first signal measurements and the second signal measurements based at least in part on the first condition and the second condition being satisfied. Additionally, or alternatively, the communication manager 140 may perform one or more other operations described herein.

As indicated above, FIG. 1 is provided as an example. Other examples may differ from what is described with regard to FIG. 1.

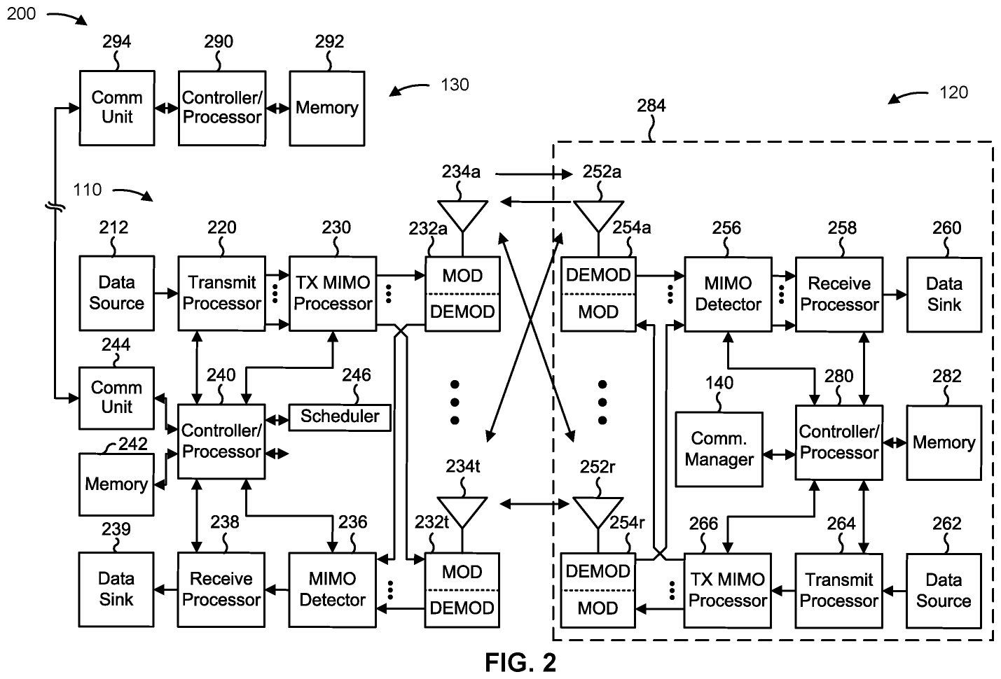

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, an RSRQ parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

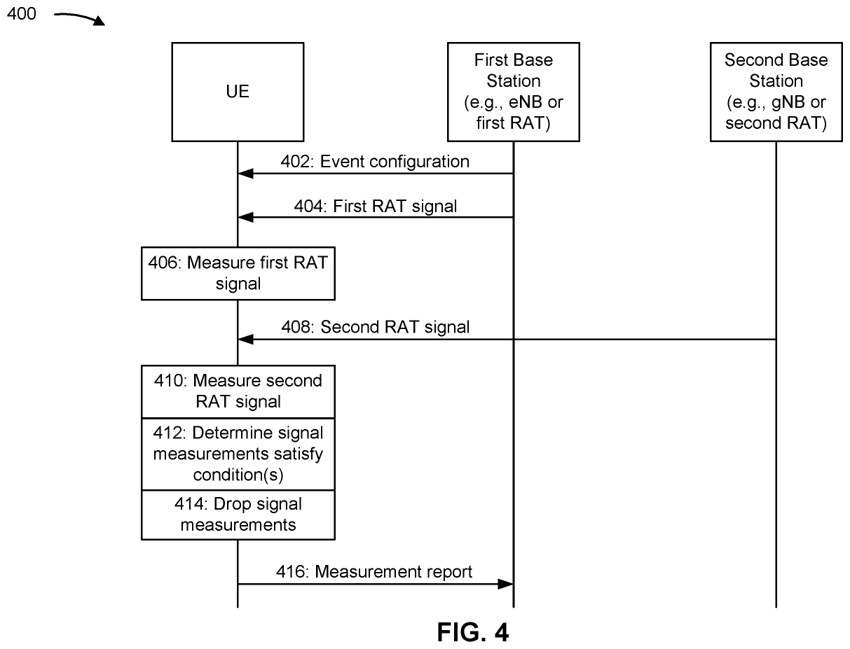

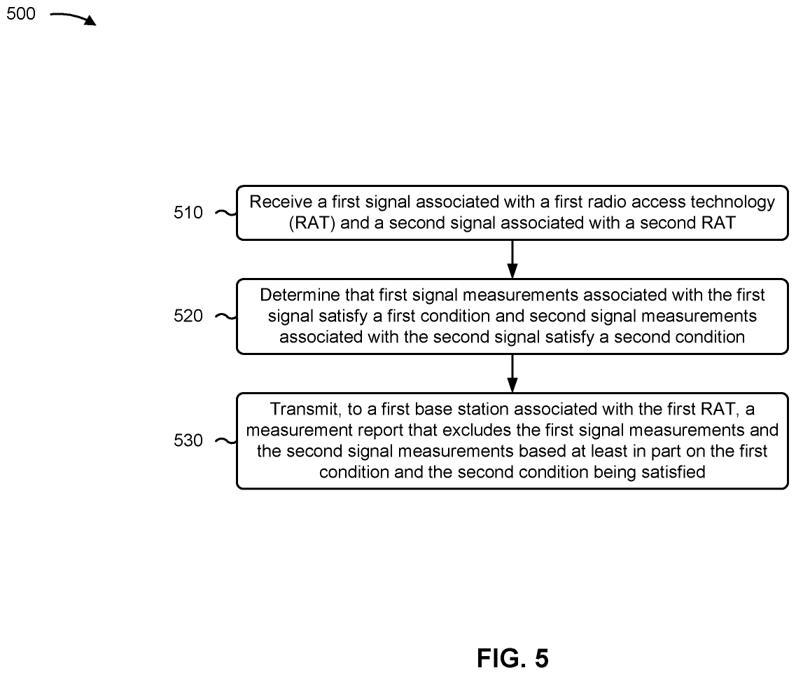

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM) and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-5).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-5).

Controller/processor 240 of base station 110, controller/processor 280 of UE 120, and/or any other component(s) of FIG. 2 may perform one or more techniques associated with excluding signal measurements from a measurement report, as described in more detail elsewhere herein. For example, controller/processor 240 of base station 110, controller/processor 280 of UE 120, and/or any other component(s) of FIG. 2 may perform or direct operations of, for example, process 500 of FIG. 5, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, and/or other processes as described herein. In some aspects, executing instructions may include running the instructions, converting the instructions, compiling the instructions, and/or interpreting the instructions.

In some aspects, a UE (e.g., UE 120) includes means for receiving a first signal associated with a first RAT and a second signal associated with a second RAT; means for determining that first signal measurements associated with the first signal satisfy a first condition and second signal measurements associated with the second signal satisfy a second condition; and/or means for transmitting, to a first base station associated with the first RAT, a measurement report that excludes the first signal measurements and the second signal measurements based at least in part on the first condition and the second condition being satisfied. The means for the user equipment (UE) to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

As indicated above, FIG. 2 is provided as an example. Other examples may differ from what is described with regard to FIG. 2.

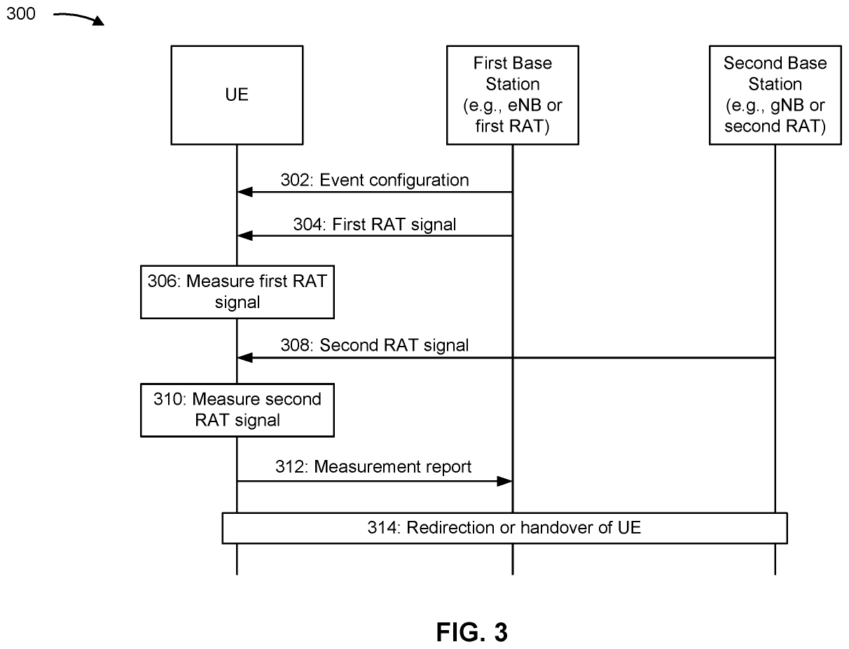

FIG. 3 is a diagram illustrating an example 300 of a handover based at least in part on signal measurements, in accordance with the present disclosure. As shown in FIG. 3, example 300 includes communication between a UE (e.g., UE 120), a first base station (e.g., base station 110a), and a second base station (e.g., base station 110d). In some aspects, the UE, the first base station, and the second base station may be included in a wireless network such as wireless network 100.

The first base station (e.g., an eNB) may be associated with an LTE network, and the second base station (e.g., gNB) may be associated with an NR network. The first base station and the LTE network may be associated with a first RAT, and the second base station and the NR network may be associated with a second RAT. In other words, LTE may be associated with the first RAT, and NR may be associated with the second RAT.

As shown by reference number 302, the UE may receive an event configuration from the first base station. The event configuration may configure a first event and a second event. For example, the event configuration may be an event B1/B2 configuration that configures an event B1 and an event B2. The event B1 may be satisfied when a signal measurement associated with the second base station satisfies a first threshold value. The event B2 may be satisfied when a signal measurement associated with the first base station does not satisfy a second threshold value, and when the signal measurement associated with the second base station satisfies the second threshold value. The first threshold value and the second threshold value may be RSRP threshold values.

As shown by reference number 304, the UE may receive a first RAT signal associated with the first base station. For example, the first RAT signal may be an LTE signal.

As shown by reference number 306, the UE may perform a measurement of the first RAT signal. The measurement of the first RAT signal may be an RSRP measurement.

As shown by reference number 308, the UE may receive a second RAT signal associated with the second base station. For example, the second RAT signal may be an NR signal.

As shown by reference number 310, the UE may perform a measurement of the second RAT signal. The measurement of the second RAT signal may be an RSRP measurement.

As shown by reference number 312, the UE may transmit a measurement report to the first base station. The measurement report may indicate the measurement of the first RAT signal associated with the first base station and the measurement of the second RAT signal associated with the second base station. In other words, the measurement report may indicate the measurement of the LTE signal and the measurement of the NR signal.

As shown by reference number 314, the UE may be handed over (or redirected) from the first base station associated with the first RAT to the second base station associated with the second RAT. The UE may be handed over to the second base station based at least in part on the measurement reporting indicating the measurement of the first RAT signal and the measurement of the second RAT signal. Specifically, the UE may be handed over to the second base station based at least in part on the first event (e.g., event B1) and the second event (e.g., event B2) being satisfied based at least in part on the measurement of the first RAT signal and/or the measurement of the second RAT signal. A handover of the UE may be initiated by the UE or the first base station based at least in part on the measurement report.

As indicated above, FIG. 3 is provided as an example. Other examples may differ from what is described with regard to FIG. 3.

In some cases, an event configuration for event B1 and event B2 may only configure RSRP threshold values, and the event configuration for event B1 and B2 may not configure RSRQ threshold values or SINR threshold values. A UE may measure an RSRP associated with an NR cell, and the RSRP may satisfy a threshold value. In other words, the RSRP associated with the NR cell may be relatively good. The UE may transmit, to a first base station associated with an LTE cell, a measurement report that indicates the RSRP associated with the NR cell. The first base station may trigger a handover of the UE to a second base station associated with the NR cell based at least in part on the measurement report indicating the RSRP associated with the NR cell.

The UE may also measure an RSRQ and/or an SINR associated with the NR cell. In some cases, the RSRQ and/or the SINR associated with the NR cell may not satisfy a threshold value (e.g., the RSRQ and/or the SINR associated with the NR cell may be relatively poor). Since the event configuration for event B1 and B2 may not configure the RSRQ threshold values or the SINR threshold values, the UE may not indicate the RSRQ and/or the SINR associated with the NR cell in the measurement report transmitted to the first base station. As a result, the first base station may not consider the RSRQ and/or the SINR associated with the NR cell when triggering the handover of the UE to the second base station associated with the NR cell.

When the UE is handed over to the NR cell associated with the relatively good RSRP but the relatively poor RSRQ and/or SINR, the UE may experience one or more failures when connected to the NR cell. For example, the UE may experience a master information block (MIB) reading failure, a system information block (SIB) reading failure, a random access channel (RACH) failure, a registration failure, and/or a relatively high block error rate (BLER). In this case, the UE may have benefited by remaining connected to the first base station and not being handed over to the second base station. In other words, the UE may have maintained a better connection remaining connected to the LTE cell rather than switching to the NR cell.

In various aspects of techniques and apparatuses described herein, a UE may receive a first signal from a first base station associated with a first RAT (e.g., LTE) and a second signal from a second base station associated with a second RAT (e.g., NR). The first RAT may be associated with an LTE serving cell and the second RAT may be associated with an NR neighbor cell. The UE may determine that first signal measurements associated with the first signal satisfy a first condition and second signal measurements associated with the second signal satisfy a second condition. The first signal measurements and the second signal measurements may be RSRP, SNR, RSRQ, and/or SINR measurements. The first condition may be satisfied when an RSRP associated with the first RAT satisfies a first threshold value and when an SNR associated with the first RAT satisfies a second threshold value. The second condition may be satisfied when an RSRQ associated with the second RAT does not satisfy a third threshold value and when an SINR associated with the second RAT does not satisfy a fourth threshold value.

In some aspects, the UE may transmit, to the first base station associated with the first RAT, a measurement report that excludes the first signal measurements and the second signal measurements based at least in part on the first condition and the second condition being satisfied. In other words, the UE may drop the first signal measurements and the second signal measurements from the measurement report based at least in part on the first condition and the second condition being satisfied. As a result, the UE may not be handed over (or redirected) to the second base station associated with the second RAT based at least in part on the first signal measurements and the second signal measurements. An exclusion of the first signal measurements and the second signal measurements from the measurement report may prevent the UE from being handed over to the second base station associated with the second RAT when the first signal measurements indicate that a signal condition of the first RAT is relatively good, and the second signal measurements indicate that a signal condition of the second RAT is relatively poor.

FIG. 4 is a diagram illustrating an example 400 of excluding signal measurements from a measurement report, in accordance with the present disclosure. As shown in FIG. 4, example 400 includes communication between a UE (e.g., UE 120), a first base station (e.g., base station 110a), and a second base station (e.g., base station 110d). In some aspects, the UE, the first base station, and the second base station may be included in a wireless network such as wireless network 100.

The first base station (e.g., an eNB) may be associated with an LTE network, and the second base station (e.g., gNB) may be associated with an NR network. The first base station and the LTE network may be associated with a first RAT, and the second base station and the NR network may be associated with a second RAT. In other words, LTE may be associated with the first RAT, and NR may be associated with the second RAT.

As shown by reference number 402, the UE may receive an event configuration from the first base station. The event configuration may configure a first event and a second event. For example, the event configuration may be an event B1/B2 configuration that configures an event B1 and an event B2. The first event may be satisfied when a signal measurement associated with the second base station satisfies a first threshold value. The second event may be satisfied when a signal measurement associated with the first base station does not satisfy a second threshold value, and when the signal measurement associated with the second base station satisfies the second threshold value. The first threshold value and the second threshold value may be RSRP threshold values.

As shown by reference number 404, the UE may receive a first RAT signal associated with the first base station. For example, the first RAT signal may be an LTE signal. A first RAT may be associated with an LTE network. The first RAT may be associated with an LTE serving cell.

As shown by reference number 406, the UE may perform a measurement based at least in part on the first RAT signal. The UE may measure an RSRP, an RSRQ, an SNR, and/or an SINR based at least in part on the first RAT signal.

As shown by reference number 408, the UE may receive a second RAT signal associated with the second base station. For example, the second RAT signal may be an NR signal. A second RAT may be associated with an NR network. The second RAT may be associated with an NR neighbor cell.

As shown by reference number 410, the UE may perform a measurement based at least in part on the second RAT signal. The UE may measure an RSRP, an RSRQ, an SNR, and/or an SINR based at least in part on the second RAT signal.

In some aspects, the RSRP, the RSRQ, the SNR, and/or the SINR associated with the first RAT signal and/or the second RAT signal may be considered as LTE-to-NR (L2NR) measurements (or first RAT-to-second RAT measurements). The L2NR measurements may enable a handover between the first base station associated with the first RAT (e.g., LTE) and the second base station associated with the second RAT (e.g., NR).

As shown by reference number 412, the UE may determine that first signal measurements associated with the first signal satisfy a first condition and second signal measurements associated with the second signal satisfy a second condition. The first condition may be satisfied when the RSRP associated with the first RAT satisfies a first threshold value and when the SNR associated with the first RAT satisfies a second threshold value. The second condition may be satisfied when the RSRQ associated with the second RAT does not satisfy a third threshold value and when the SINR associated with the second RAT does not satisfy a fourth threshold value.

In some aspects, the UE may determine that a serving LTE cell RSRP is greater than a serving LTE RSRP threshold (Th_Serving_LTE_Rsrp), and that a serving LTE cell frequency tracking loop (FTL) SNR is greater than a serving LTE FTL SNR threshold (Th_Serving_LTE_FtlSnr). Further, the UE may determine that an NR neighbor cell RSRQ is less than an NR RSRQ threshold (Th_NR_Rsrq), and that an NR neighbor cell SINR is less than an NR SINR threshold (Th_NR_Sinr). The serving LTE RSRP threshold may be associated with the first threshold value, the serving LTE FTL SNR threshold may be associated with the second threshold value, the NR RSRQ threshold may be associated with the third threshold value, and the NR SINR threshold may be associated with the fourth threshold value.

In some aspects, a default setting for the serving LTE RSRP threshold may be approximately −117 dBm. A default setting for the serving LTE FTL SNR threshold may be −6 dB. A default setting for the NR RSRQ threshold may be −16 dB. A default setting for the NR SINR threshold may be −6 dB.

As shown by reference number 414, the UE may drop the first signal measurements and the second signal measurements from a measurement report based at least in part on the first condition and the second condition being satisfied. The first signal measurements and the second signal measurements may be associated with an L2NR report (or a first RAT-to-second RAT report) that is dropped from the measurement report. The UE may exclude the first signal measurements and the second signal measurements from the measurement report based at least in part on the first condition and the second condition being satisfied.

In some aspects, the UE may exclude the first signal measurements and the second signal measurements from the measurement report based at least in part on the first event and the second event being satisfied. For example, the first event and the second event may be satisfied based at least in part on the first RAT signal and the second RAT signal, and as a result, the first signal measurements and the second signal measurements may be excluded from the measurement report.

In some aspects, when event B1 and event B2 are satisfied, the UE may drop the L2NR report from the measurement report when the serving LTE cell RSRP is greater than the serving LTE RSRP threshold, the serving LTE cell FTL SNR is greater than the serving LTE FTL SNR threshold, the NR neighbor cell RSRQ is less than the NR RSRQ threshold, and the NR neighbor cell SINR is less than the NR SINR threshold. In other words, when event B1 and event B2 are satisfied, the UE may drop the L2NR report from the measurement report based at least in part on the LTE serving cell having relatively good radio frequency (RF) conditions and the NR neighbor cell having relatively poor RF conditions.

As shown by reference number 416, the UE may transmit, to the first base station associated with the first RAT, the measurement report that excludes the first signal measurements and the second signal measurements based at least in part on the first condition and the second condition being satisfied. The measurement report may include other information but may not include the L2NR report containing the first signal measurements and the second signal measurements.

In some aspects, the UE may transmit the measurement report when the UE needs to send other measurements associated with a same measurement identifier (ID) as compared to the first signal measurements and the second signal measurements. When the UE does not have other measurements associated with the same measurement ID of the first signal measurements and the second signal measurements, which are dropped, the UE may not transmit any measurement report to the first base station.

In some aspects, a measurement report (e.g., an event B1/B2 measurement report) including L2NR measurements may not be transmitted to the first base station associated with LTE. As a result, the first base station may not hand over the UE to the second base station associated with NR based at least in part on the RSRP measurements, since RSRQ and/or SINR measurements which are unaccounted for by the first base station may be relatively poor and the UE may benefit from remaining connected to the first base station and not being handed over to the second base station. In other words, for L2NR measurements indicating a relatively poor RSRQ and/or SINR, those L2NR measurements may be pruned from the measurement report such that the UE may avoid being handed over to an NR cell having the relatively poor RSRQ and/or SINR. When a plurality of NR cells are associated with a relatively poor RSRQ and/or SINR, the UE may rather stay connected to LTE and not move to NR.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with techniques for excluding signal measurements from a measurement report.

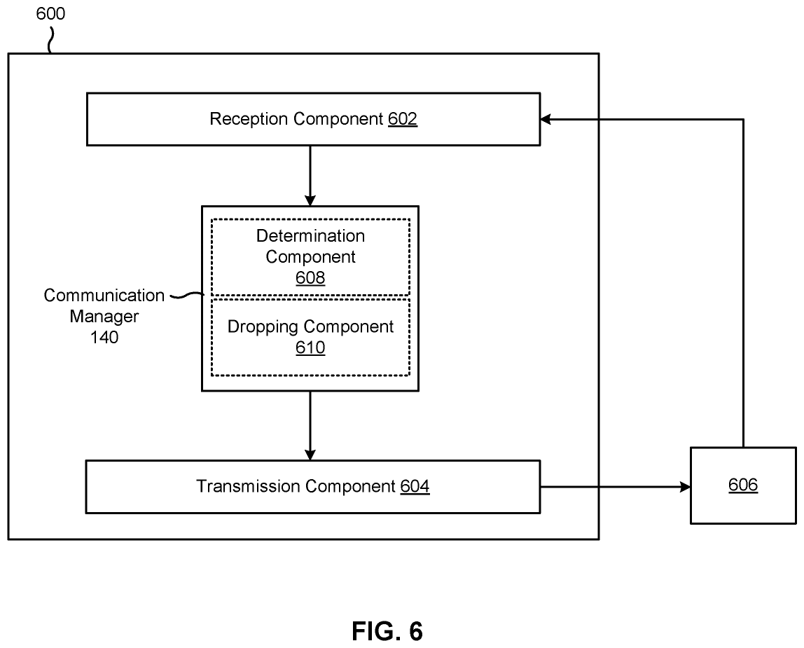

As shown in FIG. 5, in some aspects, process 500 may include receiving a first signal associated with a first RAT and a second signal associated with a second RAT (block 510). For example, the UE (e.g., using communication manager 140 and/or reception component 602, depicted in FIG. 6) may receive a first signal associated with a first RAT and a second signal associated with a second RAT, as described above.

As further shown in FIG. 5, in some aspects, process 500 may include determining that first signal measurements associated with the first signal satisfy a first condition and second signal measurements associated with the second signal satisfy a second condition (block 520). For example, the UE (e.g., using communication manager 140 and/or determination component 608, depicted in FIG. 6) may determine that first signal measurements associated with the first signal satisfy a first condition and second signal measurements associated with the second signal satisfy a second condition, as described above.

As further shown in FIG. 5, in some aspects, process 500 may include transmitting, to a first base station associated with the first RAT, a measurement report that excludes the first signal measurements and the second signal measurements based at least in part on the first condition and the second condition being satisfied (block 530). For example, the UE (e.g., using communication manager 140 and/or transmission component 604, depicted in FIG. 6) may transmit, to a first base station associated with the first RAT, a measurement report that excludes the first signal measurements and the second signal measurements based at least in part on the first condition and the second condition being satisfied, as described above.

Process 500 may include additional aspects, such as any single aspect or any combination of aspects described below and/or in connection with one or more other processes described elsewhere herein.

In a first aspect, the first RAT is associated with an LTE network and the second RAT is associated with an NR network, and wherein the first signal is associated with an LTE cell and the second signal is associated with an NR cell.

In a second aspect, alone or in combination with the first aspect, the first RAT is associated with a serving cell and the second RAT is associated with a neighbor cell.

In a third aspect, alone or in combination with one or more of the first and second aspects, the first condition is satisfied when an RSRP associated with the first RAT satisfies a first threshold value and when an SNR associated with the first RAT satisfies a second threshold value.

In a fourth aspect, alone or in combination with one or more of the first through third aspects, the second condition is satisfied when an RSRQ associated with the second RAT does not satisfy a third threshold value and when an SINR associated with the second RAT does not satisfy a fourth threshold value.

In a fifth aspect, alone or in combination with one or more of the first through fourth aspects, process 500 includes receiving, from the first base station, an event configuration associated with a first event and a second event, wherein the first event and the second event are satisfied based at least in part on the first signal and the second signal.

In a sixth aspect, alone or in combination with one or more of the first through fifth aspects, the UE is not handed over or redirected to a second base station associated with the second RAT based at least in part on the first signal measurements and the second signal measurements.

In a seventh aspect, alone or in combination with one or more of the first through sixth aspects, process 500 includes dropping the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include one or more of a determination component 608, or a dropping component 610, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be co-located with the reception component 602 in a transceiver.

The reception component 602 may receive a first signal associated with a first RAT and a second signal associated with a second RAT. The determination component 608 may determine that first signal measurements associated with the first signal satisfy a first condition and second signal measurements associated with the second signal satisfy a second condition. The transmission component 604 may transmit, to a first base station associated with the first RAT, a measurement report that excludes the first signal measurements and the second signal measurements based at least in part on the first condition and the second condition being satisfied.

The reception component 602 may receive, from the first base station, an event configuration associated with a first event and a second event, wherein the first event and the second event are satisfied based at least in part on the first signal and the second signal. The dropping component 610 may drop the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a user equipment (UE), comprising: receiving a first signal associated with a first radio access technology (RAT) and a second signal associated with a second RAT; determining that first signal measurements associated with the first signal satisfy a first condition and second signal measurements associated with the second signal satisfy a second condition; and transmitting, to a first base station associated with the first RAT, a measurement report that excludes the first signal measurements and the second signal measurements based at least in part on the first condition and the second condition being satisfied.

Aspect 2: The method of Aspect 1, wherein the first RAT is associated with a Long Term Evolution network and the second RAT is associated with a New Radio network, and wherein the first signal is associated with a Long Term Evolution cell and the second signal is associated with a New Radio cell.

Aspect 3: The method of any of Aspects 1 through 2, wherein the first RAT is associated with a serving cell and the second RAT is associated with a neighbor cell.

Aspect 4: The method of any of Aspects 1 through 3, wherein the first condition is satisfied when a reference signal received power associated with the first RAT satisfies a first threshold value and when a signal-to-noise ratio associated with the first RAT satisfies a second threshold value.

Aspect 5: The method of any of Aspects 1 through 4, wherein the second condition is satisfied when a reference signal received quality associated with the second RAT does not satisfy a third threshold value and when a signal-to-noise-plus-interference ratio associated with the second RAT does not satisfy a fourth threshold value.

Aspect 6: The method of any of Aspects 1 through 5, further comprising: receiving, from the first base station, an event configuration associated with a first event and a second event, wherein the first event and the second event are satisfied based at least in part on the first signal and the second signal.

Aspect 7: The method of any of Aspects 1 through 6, wherein the UE is not handed over or redirected to a second base station associated with the second RAT based at least in part on the first signal measurements and the second signal measurements.

Aspect 8: The method of any of Aspects 1 through 7, further comprising: dropping the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

Aspect 9: An apparatus for wireless communication at a device, comprising a processor; memory coupled with the processor; and instructions stored in the memory and executable by the processor to cause the apparatus to perform the method of one or more of Aspects 1-8.

Aspect 10: A device for wireless communication, comprising a memory and one or more processors coupled to the memory, the one or more processors configured to perform the method of one or more of Aspects 1-8.

Aspect 11: An apparatus for wireless communication, comprising at least one means for performing the method of one or more of Aspects 1-8.

Aspect 12: A non-transitory computer-readable medium storing code for wireless communication, the code comprising instructions executable by a processor to perform the method of one or more of Aspects 1-8.

Aspect 13: A non-transitory computer-readable medium storing a set of instructions for wireless communication, the set of instructions comprising one or more instructions that, when executed by one or more processors of a device, cause the device to perform the method of one or more of Aspects 1-8.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a first signal associated with a first radio access technology (RAT) and a second signal associated with a second RAT;
determining that first signal measurements associated with the first signal satisfy a first condition and second signal measurements associated with the second signal satisfy a second condition; and
transmitting, to a first base station associated with the first RAT, a measurement report that excludes the first signal measurements and the second signal measurements based at least in part on the first condition and the second condition being satisfied.

2. The method of claim 1, wherein the first RAT is associated with a Long Term Evolution network and the second RAT is associated with a New Radio network, and wherein the first signal is associated with a Long Term Evolution cell and the second signal is associated with a New Radio cell.

3. The method of claim 1, wherein the first RAT is associated with a serving cell and the second RAT is associated with a neighbor cell.

4. The method of claim 1, wherein the first condition is satisfied when a reference signal received power associated with the first RAT satisfies a first threshold value and when a signal-to-noise ratio associated with the first RAT satisfies a second threshold value.

5. The method of claim 1, wherein the second condition is satisfied when a reference signal received quality associated with the second RAT does not satisfy a third threshold value and when a signal-to-noise-plus-interference ratio associated with the second RAT does not satisfy a fourth threshold value.

6. The method of claim 1, further comprising:
receiving, from the first base station, an event configuration associated with a first event and a second event, wherein the first event and the second event are satisfied based at least in part on the first signal and the second signal.

7. The method of claim 1, wherein the UE is not handed over or redirected to a second base station associated with the second RAT based at least in part on the first signal measurements and the second signal measurements.

8. The method of claim 1, further comprising:
dropping the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

9. A user equipment (UE) for wireless communication, comprising:
a memory; and
one or more processors, coupled to the memory, configured to:
receive a first signal associated with a first radio access technology (RAT) and a second signal associated with a second RAT;
determine that first signal measurements associated with the first signal satisfy a first condition and second signal measurements associated with the second signal satisfy a second condition; and
transmit, to a first base station associated with the first RAT, a measurement report that excludes the first signal measurements and the second signal measurements based at least in part on the first condition and the second condition being satisfied.

10. The UE of claim 9, wherein the first RAT is associated with a Long Term Evolution network and the second RAT is associated with a New Radio network.

11. The UE of claim 9, wherein the first RAT is associated with a serving cell and the second RAT is associated with a neighbor cell.

12. The UE of claim 9, wherein the first condition is satisfied when a reference signal received power associated with the first RAT satisfies a first threshold value and when a signal-to-noise ratio associated with the first RAT satisfies a second threshold value.

13. The UE of claim 9, wherein the second condition is satisfied when a reference signal received quality associated with the second RAT does not satisfy a third threshold value and when a signal-to-noise-plus-interference ratio associated with the second RAT does not satisfy a fourth threshold value.

14. The UE of claim 9, wherein the one or more processors are further configured to:
receive, from the first base station, an event configuration associated with a first event and a second event, wherein the first event and the second event are satisfied based at least in part on the first signal and the second signal.

15. The UE of claim 9, wherein the UE is not handed over or redirected to a second base station associated with the second RAT based at least in part on the first signal measurements and the second signal measurements.

16. The UE of claim 9, wherein the one or more processors are further configured to:
drop the first signal measurements and the second signal measurements from the measurement report based at least in part on the first condition and the second condition being satisfied, wherein the first signal measurements and the second signal measurements are associated with a first RAT-to-second RAT report that is dropped from the measurement report.

17. A non-transitory computer-readable medium storing a set of instructions for wireless communication, the set of instructions comprising:
one or more instructions that, when executed by one or more processors of a user equipment (UE), cause the UE to:
receive a first signal associated with a first radio access technology (RAT) and a second signal associated with a second RAT;
determine that first signal measurements associated with the first signal satisfy a first condition and second signal measurements associated with the second signal satisfy a second condition; and
transmit, to a first base station associated with the first RAT, a measurement report that excludes the first signal measurements and the second signal measurements based at least in part on the first condition and the second condition being satisfied.

18. The non-transitory computer-readable medium of claim 17, wherein the first RAT is associated with a Long Term Evolution network and the second RAT is associated with a New Radio network.

19. The non-transitory computer-readable medium of claim 17, wherein the first RAT is associated with a serving cell and the second RAT is associated with a neighbor cell.

20. The non-transitory computer-readable medium of claim 17, wherein the second condition is satisfied when a reference signal received power associated with the first RAT satisfies a first threshold value and when a signal-to-noise ratio associated with the first RAT satisfies a second threshold value.

21. The non-transitory computer-readable medium of claim 17, wherein the first condition is satisfied when a reference signal received quality associated with the second RAT does not satisfy a third threshold value and when a signal-to-noise-plus-interference ratio associated with the second RAT does not satisfy a fourth threshold value.

22. The non-transitory computer-readable medium of claim 17, wherein the one or more instructions further cause the UE to:
receive, from the first base station, an event configuration associated with a first event and a second event, wherein the first event and the second event are satisfied based at least in part on the first signal and the second signal.

23. The non-transitory computer-readable medium of claim 17, wherein the UE is not handed over or redirected to a second base station associated with the second RAT based at least in part on the first signal measurements and the second signal measurements.

24. An apparatus for wireless communication, comprising:
means for receiving a first signal associated with a first radio access technology (RAT) and a second signal associated with a second RAT;
means for determining that first signal measurements associated with the first signal satisfy a first condition and second signal measurements associated with the second signal satisfy a second condition; and
means for transmitting, to a first base station associated with the first RAT, a measurement report that excludes the first signal measurements and the second signal measurements based at least in part on the first condition and the second condition being satisfied.

25. The apparatus of claim 24, wherein the first RAT is associated with a Long Term Evolution network and the second RAT is associated with a New Radio network.

26. The apparatus of claim 24, wherein the first RAT is associated with a serving cell and the second RAT is associated with a neighbor cell.

27. The apparatus of claim 24, wherein the first condition is satisfied when a reference signal received power associated with the first RAT satisfies a first threshold value and when a signal-to-noise ratio associated with the first RAT satisfies a second threshold value.

28. The apparatus of claim 24, wherein the second condition is satisfied when a reference signal received quality associated with the second RAT does not satisfy a third threshold value and when a signal-to-noise-plus-interference ratio associated with the second RAT does not satisfy a fourth threshold value.

29. The apparatus of claim 24, further comprising:
means for receiving, from the first base station, an event configuration associated with a first event and a second event, wherein the first event and the second event are satisfied based at least in part on the first signal and the second signal.

30. The apparatus of claim 24, wherein the apparatus is not handed over or redirected to a second base station associated with the second RAT based at least in part on the first signal measurements and the second signal measurements.
